(19) United States
(12) Patent Application Publication
(10) Pub. No.: US 2013/0271595 A1
(43) Pub. Date: Oct. 17, 2013

(54) CIRCUIT PATTERN INSPECTING DEVICE AND INSPECTING METHOD THEREOF

(71) Applicants: Takashi Hiroi, Yokohama (JP); Masaaki Nojiri, Yokohama (JP); Takuma Yamamoto, Mito (JP); Taku Ninomiya, Hitachinaka (JP)

(72) Inventors: Takashi Hiroi, Yokohama (JP); Masaaki Nojiri, Yokohama (JP); Takuma Yamamoto, Mito (JP); Taku Ninomiya, Hitachinaka (JP)

(73) Assignee: HITACHI HIGH-TECHNOLOGIES CORPORATION, Tokyo (JP)

(21) Appl. No.: 13/978,095

(22) PCT Filed: Nov. 11, 2011
(86) PCT No.: PCT/JP2011/006306

§ 371 Date: Jul. 2, 2013

(30) Foreign Application Priority Data
Jan. 21, 2011 (JP) 2011-010355

(51) Int. Cl. G06T 7/00

(52) U.S. Cl. CPC G06T 7/0004
USPC 348/80

(57) ABSTRACT

Provided are a high speed circuit pattern inspecting method and inspecting device which have a short preparation time for inspection and are capable of determining a defect by detecting only an image of one die. A coordinate which is expected to obtain the same pattern as a corresponding coordinate and an alignment coordinate are selected by referring to design information. The detected image and the design information are aligned using the alignment coordinate to correct the deviated amount and a pattern of the corresponding coordinate is compared with a pattern of the coordinate which is expected to obtain the same pattern to compare the patterns by detecting only an image of one die.

### TECHNICAL FIELD

The present invention relates to a technique of an inspecting device and an inspecting method which inspect a semiconductor device or a substrate device having a circuit pattern such as liquid crystal using an electron beam.

### BACKGROUND ART

An electron beam inspecting device is a device which obtains an image of a sample using an electron scanning microscope and performs various image processings on an obtained image to inspect whether there is a defect. An electron beam is scanned on a wafer, a mask or a liquid crystal substrate which is an inspecting target and a generated secondary electron or a reflected electron is detected in synchronization with the movement of a stage. A secondary electron image of a circuit pattern on the wafer obtained described above is compared with a pattern in other position to determine a location having a large difference as a defect. Since the circuit pattern formed on the wafer has a periodicity, the defect may be detected by the comparison. If the pattern to be compared is in the same location as the adjacent die, the comparison is called as die comparison and if the pattern to be compared is in an adjacent cell in a memory mat area, the comparison is called as cell comparison.

Further, other than a comparison calculating method which sequentially changes patterns to be compared, there is a defect inspecting method which fixes the pattern to be compared to an arbitrarily determined pattern and considers the pattern as a reference image to be a comparison calculating target. As the reference image, image information generated from design information of the circuit pattern in addition to a captured image of an actual pattern formed on the wafer may be used. In this case, a pattern having a large difference from the design value may be detected as a defect. In addition, distribution of the detected defects on the wafer is statistically analyzed or a shape and a property of the detected defect are analyzed in detail so as to be fed back to control a manufacturing process of the wafer. That is, the distribution, and the shape and property of the defect are used to analyze a problem during the manufacturing of the wafer which has the defect.

Patent Literature 1 discloses a die and database inspecting method which compares a grayscale image generated from the design information of the circuit pattern with an actually captured image.

Not only comparison inspection of grayscale information between images, but also contour information of the circuit pattern may be used to inspect the defect. Japanese Patent No. 3524853 (Patent Literature 2) discloses an inspecting device which extracts boundary information (edge information) of a circuit pattern from design information of a circuit pattern and extracts contour line information from a circuit pattern included in a captured image to compare both information.

Further, Japanese Patent Application Laid-Open No. 2009-194051 (Patent Literature 3) discloses an inspecting method which obtains images from a plurality of given image capturing locations, accumulates same pattern included in the images to generate a reference pattern, and compares an average contour image generated by detecting a contour line from the reference pattern with a contour image generated from the obtained image.

Further, even though different from the inspecting device, Japanese Patent Application Laid-Open No. 2009-283917 (Patent Literature 4) discloses an invention of a device which detects positional information of the vicinity of a detected defect which may be used as a reference image using design information of a circuit pattern in a defect observing device called as a defect review SEM which reads positional information of a defect detected by an appearance inspecting device and recaptures the detected defect at a high resolution.

### CITATION LIST

Patent Literature

Patent Literature 1: Japanese Unexamined Patent Application Publication No. Hei5(1993)-258703 (U.S. Pat. No. 5,502,306)

Patent Literature 2: Japanese Patent No. 3524853 (U.S. Pat. No. 6,868,175)

Patent Literature 3: Japanese Unexamined Patent Application Publication No. 2009-194051 (U.S. Patent Application Laid-Open No. 2009/0202139)

Patent Literature 4: Japanese Unexamined Patent Application Publication No. 2009-283917 (U.S. Patent Application Laid-Open No. 2009/0268959)

### SUMMARY OF INVENTION

Technical Problem

In an electron beam appearance inspecting device or a so-called electronic beam pattern inspecting device which is also called as a defect review device having a defect inspecting function, in some cases, even in a case of inspecting a plurality of dies, a defect is inspected using only an image of one die or a defect is required to be inspected using an image of one die. For example, in the case of a photo mask (also referred to as a reticle) in a semiconductor process, a circuit having a plurality of prototype chips is generally mounted in one mask set in a prototype reticle, so that it is required to detect a defect using an image of one die. Further, also in actual inspection of a wafer, in a wafer which flows to a prototype line or a manufacturing line of a wide variety of products in small quantities, a plurality of different dies may be mounted in one shot so that defect inspection which uses an image of one die is required.

Further, in a wafer where lots of logics such as CPUs are mounted, a size of a die is large and only one die may be mounted in one reticle. If reticle inspection is difficult due to EUV exposure or a pellicle which prevents extraneous materials from being attached onto the reticle cannot be mounted, or in order to verify whether a pattern produced by an OPC is an expected pattern, a reticle pattern needs to be exposed on the wafer and a transferred pattern needs to be inspected. In these cases, it is required to verify or monitor whether the transferred pattern is properly formed as its designed function, a purposed defect may not be detected in comparison with adjacent die, a memory mat portion may be inspected in cell comparison but portions around the memory mat or peripheral circuits may not be inspected. In these cases, it is required to detect a defect using an image of only one die.

However, in the conventional method, it takes so much time to prepare inspection or the inspection cannot be performed.

For example, in case of inspection of a die and database comparison method disclosed in Patent Literatures 1 and 2, it is required t o prepare image data which is compared with a captured SEM (scanning electron microscope) image but the circuit pattern formed on the reticle may not be a pattern according to the design information but may be modified by an OPC. Accordingly, a simulation of a shape of the mask in consideration of a pattern modification is required in reticle inspection, a simulation of transferring a mask (lithography simulation) and a simulation for estimating a detected image from a transferred pattern are required in wafer inspection in addition to the simulation of mask modification. However, an amount of calculation accompanied with the above simulations is huge and if a size of a defect to be detected is small, it is difficult to estimate a modified amount. In the inspecting method which uses the edge information disclosed in Patent Document 2, the amount of calculation is smaller than that of an inspecting method using a grayscale image, but similarly to the above method, the above-mentioned simulations need to be performed.

In the invention disclosed in Patent Literature 3, the average contour line is created from an actual image so that the simulation is not required, but a plurality of images having the same pattern needs to be acquired in advance in order to create the average contour line. Accordingly, the invention is not appropriate for the inspection in situations where the circuit pattern to be inspected is frequently changed or a normal pattern is not obtained at the time of development or a pattern close to the entire surface of the die is required to be inspected. Further, according to Patent Literature 3, even though these patterns are obtained by capturing images in the same location of adjacent chips or the different wafers or accumulating a plurality of pixels having the same pattern present in the same FOV (field of view), the former method is not applicable to the inspection which uses an image of one die and in the latter method, if the same pattern is not present in the FOV, the inspection is impossible.

The invention disclosed in Patent Literature 4 is an invention which relates to a defect observing device and requires positional information of the defect to search a position of a reference image from design information.

As described above, each method has both merits and demerits but a circuit pattern inspecting device and method which may quickly determine a defect using an image of one die with a short pre-preparation time required for the inspection are not achieved. The present invention is directed to achieve a circuit pattern inspecting device and method which are capable of performing the inspection.

Solution to Problem

The present invention extracts positional information in a die which needs to be the same design pattern using design information of a pattern to be inspected, obtains images of at least two of a plurality of extracted positional information, and detects a defect using the obtained images to solve the above-mentioned problems. Any of grayscale information and contour information may be used for the defect detecting method.

In other words, the present invention determines a position where an image required detecting the defect is captured in advance and then obtains the image to solve the problems. Alternatively, a pair of comparison calculations for detecting the defect is determined from design information of one chip in advance and the image is obtained from the pair of comparison calculations to solve the problems.

Advantageous Effects of Invention

According to the present invention, the simulation is not required so that an inspection preparation time is significantly shortened as compared with the die and database inspection of the related art. Therefore, it is possible to provide a high speed electron beam pattern inspecting device and an inspecting method which have a short preparation time for inspection and are capable of determining a defect by detecting an image of one die.

### BRIEF DESCRIPTION OF DRAWINGS

FIG. 1 is a concept explanatory view of an algorithm for determining a pair of partial images which is used for comparison calculation for detecting a defect using design information.

FIG. 2 is a view of an entire configuration of an inspecting device according to a first embodiment.

FIG. 3 is a flowchart of an inspecting method according to the first embodiment.

FIG. 4 is a conceptual view illustrating a relationship between a hierarchal structure of design information and a pair of comparison calculations.

FIG. 5 is a schematic view illustrating a die layout and a swath layout.

FIG. 6 is a view illustrating a configuration example of hardware of a defect determining unit and a configuration example of a functional block of an inspecting device according to the first embodiment.

FIG. 7 is a view illustrating a defect determining method and functional blocks of a defect determining processing of an inspecting device according to a fourth embodiment.

FIG. 8 is a view illustrating a defect determining method and functional blocks of a defect determining processing of an inspecting device according to a fifth embodiment.

FIG. 9 is a view illustrating a defect determining method and functional blocks of a defect determining processing of an inspecting device according to a sixth embodiment.

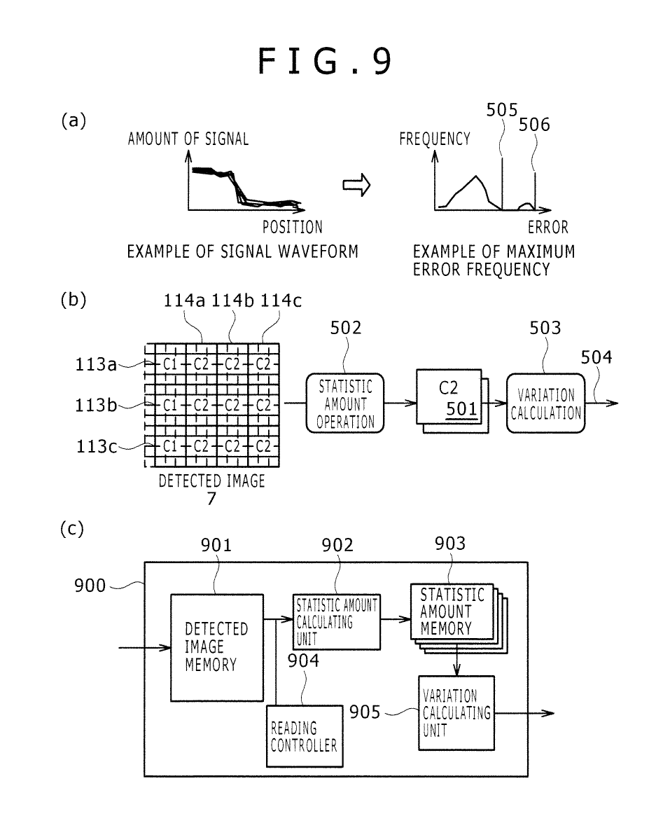

### DESCRIPTION OF EMBODIMENTS

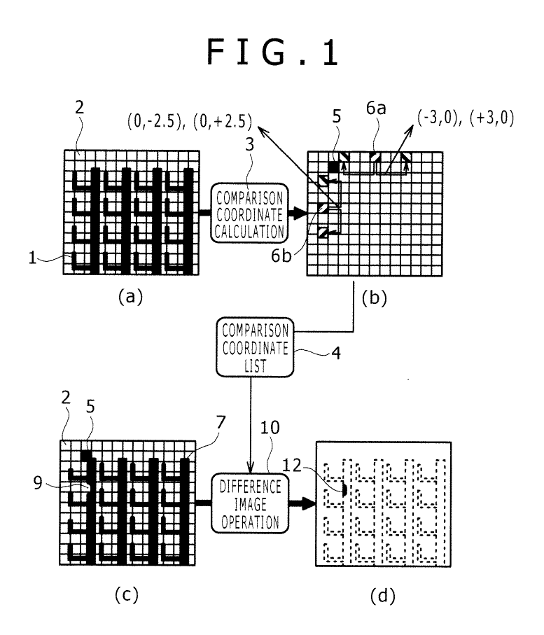

Hereinafter, an inspecting principle which is common to the embodiments will be described with reference to FIG. 1. Even though the invention is described to be limited to the inspection of a semiconductor wafer or a semiconductor mask, it is obvious that the invention is applicable to other samples to be inspected, for example, a semiconductor device (semiconductor apparatus) or liquid crystal.

FIG. 1 is a conceptual view illustrating a process of preparation prior to inspection of an object to be inspected using design information and a defect determining method from a detected image. As illustrated in FIG. 1(a) , a design pattern 1 obtained from design information such as GDS2 data or OASIS is virtually divided into meshes 2 and a coordinate of a position which needs to have the same pattern is extracted by comparison coordinate calculation 3 in an appropriate calculator for every mesh to be created as a comparison coordinate list 4. The mesh size is determined by multiplying a unit of switching (the number of pixels which are processed at one time at the time of a calculation processing) the processing at the time of an image processing and a size of a pixel. It is assumed that the size of the pixel is 2 nm to 30 nm and the unit of switching the image processing is 32 pixels to 1,024 pixels, and a range of the mesh size is approximately 64 nm to 30 μm. For example, if it is assumed that the size of the pixel is 10 nm and the unit of switching the processing of the image processing is 128 pixels, the mesh size is 1.28 μm. If it is determined to be the same pattern, the determination is performed such that an influencing range of OPC or an adjacent pattern having a predominant influence on an image is included in an outer side of the mesh so as to more precisely determine the pattern.

FIG. 1(b) is a conceptual view illustrating a relationship of the mesh illustrated in FIG. 1(a) and the same pattern position coordinate included in the comparison coordinate list 4. For example, a position shifted from a mesh 6a by three meshes at right and left sides is a position having the same pattern and a position shifted from a mesh 6b by 2.5 meshes at lower and upper sides is a position where the same pattern is formed. The comparison coordinate list 4 at least includes an ID of each of the meshes illustrated in FIG. 1(a) , positional information of a comparison target of a mesh of the corresponding ID, and positional information of alignment mesh {mesh 5 in FIG. 1(b)}. The correspondence of the coordinate of each of the positions divided into the meshes and the ID is determined in advance. In the following description, the positional information of the alignment mesh (for example, positional information of the mesh 5) and positional information of an object to be compared with respect to an arbitrary mesh ID (for example, in the case of a mesh 6a, offset information of a mesh unit such as (−3, 0) and (+3, 0)) are collectively referred to as an “alignment coordinate list” and a “same coordinate list”, respectively, which are included in the comparison coordinate list 4.

As a pattern of the positional information of the object to be compared which is stored in the same coordinate list, even though offset information having a mesh as a unit and two offset information of a positional offset of a pattern with respect to the mesh are required, coordinate information such as a relative offset coordinate in the unit of a pixel on a digital image and a relative coordinate on a design pattern maybe directly stored. The two latter methods substantially include an offset in the unit of a mesh according to the initial method and an offset in the mesh.

FIG. 1(c) illustrates an SEM image (detected image 7) which is actually detected. The captured detected image 7 is divided into meshes 8, which is similar to the design pattern 1. It is assumed that the detected image 7 includes a defect 9. In the following description, an image in each of meshes of detected images which are divided into the meshes is referred to as a “partial image”. A partial image corresponding to an alignment mesh 5 among the detected images 7 is aligned with respect to a design pattern 1 and thus a coordinate of each of the partial images is set and a range of the partial image cut from the detected image 7 is set. Further, the alignment meshes are disposed with an appropriate interval in accordance with a range where an amount of alignment is not changed so much. In addition, a unique pattern which does not match a separate pattern in a range of an amount of deviated position which may occur by electrification is required for the alignment. However, if there is no unique pattern which satisfies a condition in a range of extracting the same pattern, the alignment is temporally performed with an appropriate pattern, a range of determining whether a pattern is the same pattern is reduced, and a unique pattern which satisfies the condition is set to perform the alignment in multiple stages. This is possible because the aligned patterns are not deviated therebetween so much. Further, the alignment mesh may be formed of only one mesh or a combination of a plurality of meshes.

If a range where the partial image is cut is set, partial images corresponding to each mesh ID and an object to be compared therewith are cut from the detected image in accordance with the comparison coordinate list, and a difference image calculation 10 is performed to determine whether there is a defect. At the time of determining a defect, the cut partial image is compared with a partial image corresponding to an object to be compared at least two times and if it is determined that a defect is found in all partial images, in addition to a processing of determining whether a defect is found, various algorithms may be used, for example, a golden pattern (a reference pattern which does not have a defect) is generated from the same pattern of a plurality of locations of the partial image corresponding to the object to be compared and the generated golden pattern is compared with the cut partial image or a golden which is obtained or calculated as additional information of the alignment information in advance is compared with the golden pattern. Further, without determining a defect by the difference image calculation, the defect may be determined using a difference of contour lines from the detected image by calculation or by combination of methods of calculating a difference image and a difference of the contour lines. FIG. 1(d) illustrates a shape of a defect 9 which is detected by the difference image calculation as a difference image 12.

In the above description, in order to simplify the description, even though one image (an image captured by one FOV) is considered as a detected image and the design pattern is divided into meshes, the meshes do not need to be uniform and may overlap or may be omitted. In other words, what the meshes may be omitted means that there is no need to determine whether there is a defect in a location where there is no pattern or a dummy pattern portion which is not relevant with a circuit operation, or a portion where it does not matter even though a large defect is found.

Further, if an important part is not disposed in the location where the meshes overlap, it does not matter about the overlapping of the meshes. Further, the detected image does not need to be uniformly obtained with the same pixel size and the image may be obtained while designating a size of a detected pixel for every mesh and dynamically changing the pixel size. Further, the image may be obtained using a stage in a step-and-repeat method such that an image of an important design portion is obtained while continuously moving a stage or dynamically changing the pixel size or an image in a plurality of meshes which is desired to be inspected or only in a mesh part of an object to be compared corresponding to an alignment mesh is obtained.

First Embodiment

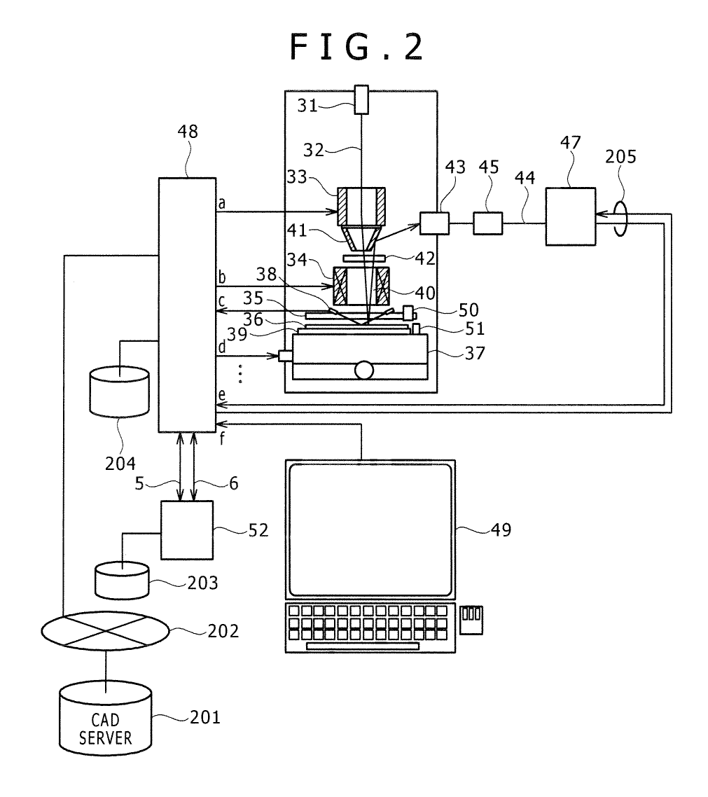

Hereinafter, a first embodiment of an inspecting method and an inspecting device according to the present invention will be described in detail with reference to drawings. FIG. 2 is a longitudinal sectional view illustrating a configuration of an inspecting device according to the embodiment.

The inspecting device of the embodiment applies a scanning electron microscope and main parts thereof are accommodated in a vacuum container. By doing this, a primary charged particle beam is irradiated on a substrate such as a semiconductor wafer. The inspecting device according to the embodiment includes a charged particle column which irradiates a primary charged particle beam 32 generated from an electron source 31 onto a wafer 36 loaded on a sample stage 39 and detects a secondary charged particle 40 such as a generated secondary electron or a generated reflected electron using a detector 43 to output a signal as a secondary charged particle signal, an XY stage 37 which moves the sample stage 39 in an XY plane, a defect determining unit 47 which converts the secondary charged particle signal output from the column into an image and compares the secondary charged particle signal with a reference image to extract a pixel having a difference in an amount of signals as a defect candidate, and an overall controller 48 which collectively controls the charged particle column, the XY stage 37, and the defect determining unit 47. A secondary storing device 204 is connected to the overall controller 48 to store software executed in the overall controller 48 or various control information. The XY stage 37 and the sample stage 39 are held in a vacuum sample chamber.

In order to converge energy of the primary charged particle beam 32 on the wafer 36, an objective lens 34 narrowly focuses the primary charged particle beam 32 so that a diameter of the primary charged particle beam 32 is very small on the wafer 36. The primary charged particle beam 32 is deflected in a predetermined area on the wafer 30 by a deflector 33 to be scanned on the wafer 36. By synchronizing a movement position by the scanning and a timing of detecting a secondary charged particle 40 by the detector 43, a two-dimensional image may be formed.

Various circuit patterns formed of various materials are formed on a surface of the wafer 36 and the surface of the wafer 36 may be appropriately charged in order to easily detect a defect in some cases. In the embodiment, a charging control electrode 35 is provided directly in front of the wafer 36 to form a desired electrical charge on the wafer 36 by an intensity and a polarity of a potential which is applied to the charging control electrode 35.

Before inspecting the wafer 36, the primary charged particle beam 32 is irradiated on a standard sample strip 51 to form an image and a coordinate of a position of irradiating the primary charged particle beam and a focal point are calibrated. As described above, the diameter of the primary charged particle beam 32 is very small and a scanning width by the deflector 33 is significantly smaller than the size of the wafer 36 so that a viewing field of the image which is capable of being obtained at one time by scanning the primary charged particle beam 32 is very small. Therefore, if the wafer 36 is loaded on the XY stage 37 before inspection, the coordinate is calibrated by detecting an alignment mark for calibrating a coordinate which is provided on the wafer 36 using an image with a comparatively low expanding magnification by an optical microscope 50 and moving the XY stage 37 to position the alignment mark below the primary charged particle beam 32.

In order to calibrate the focal point, a height of the standard sample strip 51 is measured by a Z sensor 38 which measures a height of the wafer 36, and then a height of the alignment mark provided on the wafer 36 is measured to adjust an excited intensity of the objective lens 34 using the measured value, so that a focal range of the primary charged particle beam 32 which is focused by the objective lens 34 includes the alignment mark.

In order to detect the secondary charged particles 40 generated in the wafer 36 as many as possible, an ExB deflector 42 causes many of the secondary charged particles 40 to be in contact with a reflective plate 41 to detect second secondary electrons generated from the reflective plate 41 using the detector 43.

The overall controller 48 controls an operation of calibrating the coordinate and an operation of calibrating a focal point described above. Further, the overall controller 48 transmits a control signal a to the deflector 33 and transmits a control signal b having an excited current intensity to the objective lens. Further, the overall controller 48 receives a measured value c of the height of the wafer 36 which is transmitted from the Z sensor 38 and transmits a control signal d which controls the XY stage 37 to the XY stage 37.

A secondary charged particle signal output from the detector 43 is converted into a digital signal 44 by an AD converter 45.

The defect determining unit 47 generates an image from the digital signal 44 and compares the image with the reference image to extract a plurality of pixels having a difference in values of the brightness as a defect candidate and transmits a defect information signal e which includes the image signal and a corresponding coordinate on the wafer 36 to the overall controller 48. The defect information signal e is transmitted to the overall controller 48 via a signal transmission line 205, and various pieces of information generated in the overall controller 48 or a comparison coordinate list calculating processor 52, which will be described below, are also transmitted to the defect determining unit 47 by the signal transmission line 205. At the time of determining the defect candidate, the various algorithms are available as described above and the defect may also be determined using contour line information.

The inspecting device according to the embodiment includes a console 49. The console 49 is connected to the overall controller 48, an image of the defect is displayed on a screen of the console 49 and the overall controller 48 calculates the control signal a of the deflector 33, the control signal b of the intensity of the objective lens, and the control signal d which controls the XY stage 37 based on an inspection condition f input by the console 49. Further, the console 49 includes a keyboard or a pointing device (mouse) which inputs the inspection condition and a user of the device manipulates the keyboard or the pointing device on a GUI screen which is displayed on the screen to input the inspection condition.

Further, the inspecting device of the embodiment includes a comparison coordinate list calculating processor 52 and has a function of generating a comparison coordinate list 4 including a same coordinate list 6 which is a coordinate list of the same pattern and the alignment coordinate list 5 based on the design information of the pattern formed on the wafer 36 in accordance with the instruction by the operator through the console 49. The comparison coordinate list calculating processor 52 may operate in parallel with the inspection operation during the inspection operation, independently from the inspection operation. In addition, a secondary storing device 203 is connected to the comparison coordinate list calculating processor 52 to store software executed in the comparison coordinate list calculating processor 52 or various control information.

Before inspection, the comparison coordinate list 4 of the pattern is created from the design information in the comparison coordinate list calculating processor 52 in accordance with the instruction from the console 49. Design data of the pattern is stored in a CAD server 201 and the CAD server 201 is connected to the overall controller 48 trough a communication network 202 such as a LAN.

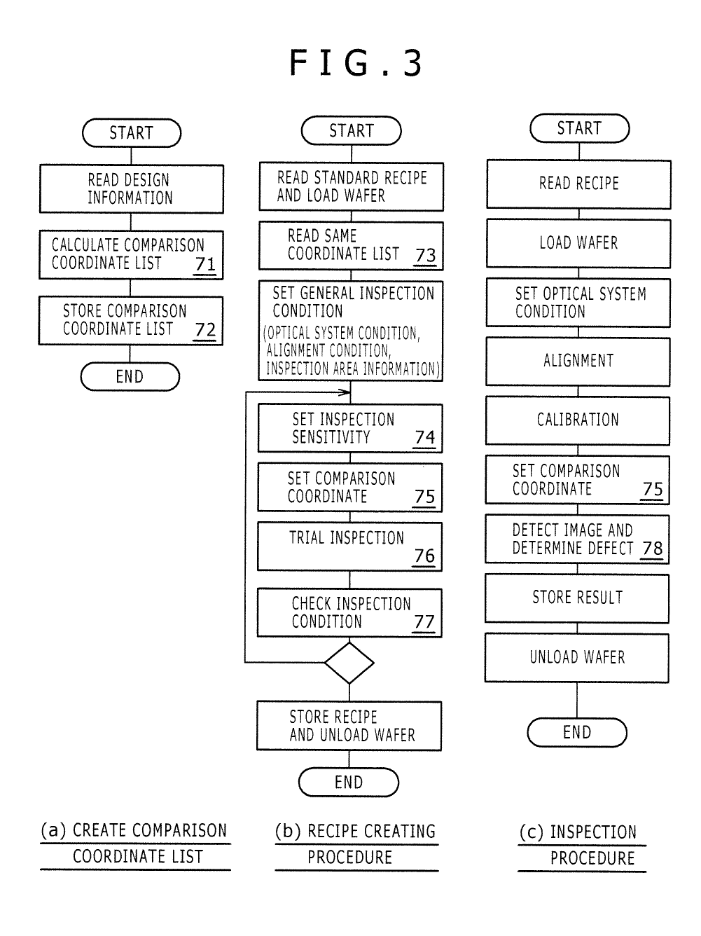

Before inspection, a recipe which determines the inspection condition and an inspection procedure is created. (a), (b), and (c) in FIG. 3 are a flowchart illustrating the comparison coordinate list calculation, a flowchart illustrating the recipe creation, and a flowchart illustrating a procedure of the main inspection performed in accordance with a set recipe, respectively.

Referring to FIG. 3(a), in accordance with the instruction from the console 49, design information of a wiring pattern or a mask pattern of a device to be inspected is read. Since the semiconductor device is generally configured by laminating wiring patterns of multiple layers, at the time of reading the design information, a type of a product or a manufacturing process (identification information of the layer) such as a wafer ID or a process ID is referenced. The design information is received in advance in the secondary storing device 203 or 204 from the CAD server 201 or read out from the CAD server 201 whenever the flow of FIG. 3(a) is performed.

The comparison coordinate list calculating processor 52 converts the read design data into the comparison coordinate list 4 (step 71) and stores the converted comparison coordinate list 4 in the secondary storing device 203 for every type and process (step 72).

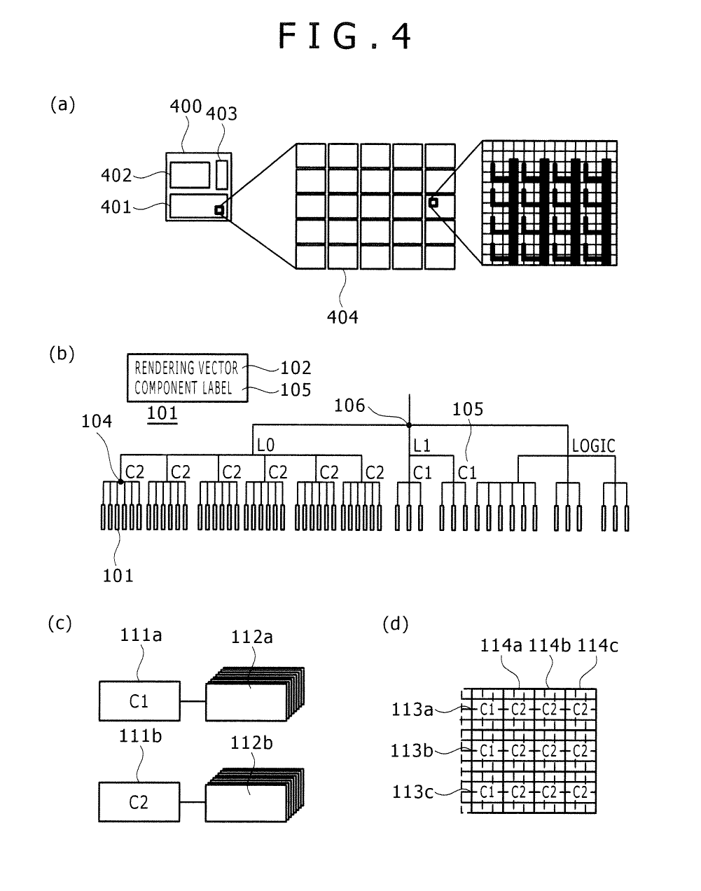

Next, a comparison coordinate list information creating step 71 illustrated in FIG. 3(a) will be described with reference to FIG. 4. FIG. 4(a) illustrates a schematic diagram of a die to be inspected, FIG. 4(b) illustrates a logical configuration example of the design information corresponding to a die layout illustrated in FIG. 4(a), FIG. 4(c) illustrates a conceptual view illustrating correspondence of label information of an area having the same pattern on the design information and positional information of an area where the same pattern is formed, and FIG. 4(d) illustrates an arrangement example of the same patterns representing the arrangement of the same pattern information.

The circuit pattern formed on the semiconductor wafer is basically formed such that the same patterns are periodically arranged. A layout in a die 400 illustrated in a left side of FIG. 4(a) is divided into a plurality of areas, for example, a memory area 401, a logic area 402, and a peripheral circuit area 403 and these areas are classified into smaller areas. For example, the memory area 401 is divided into smaller constituent units such as a plurality of memory mats 404 illustrated in the center of FIG. 4(a) and finally divided into minimum constituent units (each rendering pattern which is printed on the wafer at the time of lithography) which configure a circuit pattern called a gate electrode of a transistor which configures a memory cell or a wiring line as illustrated in a right side of FIG. 4(a).

In the meantime, from a periodicity of a formed pattern, the design information of the circuit pattern may be logically represented by a hierarchal structure as illustrated in FIG. 4(b) . Rendering data 101 is disposed at a bottom hierarchy and a plurality of rendering data 101 is combined to form a higher constituent unit of the circuit pattern. Therefore, branches of the hierarchal structure correspond to higher constituent units obtained by combining lower structural units. In the following description, a constituent unit corresponding to a branch and a leaf which is lower than an arbitrary branch of the hierarchal structure is referred to as a “part” of the corresponding constituent unit. Same rendering data may be shared in locations having different hierarchal structures.

A rendering vector 102 which describes a pattern formed on the wafer and a part label 105 are attached to the rendering data 101 at the bottom layer. The part label 105 which describes a part name, such as C1 or C2 and a plurality of rendering data 101 required to configure the part are included in a part 104 which is one hierarchy higher than the rendering data at the bottom layer. Further, a part label which describes a part name, such as L0, L1, or Logic and information of labels of lower parts which configures parts are included in the parts which are one hierarchy higher than the part 104. The plurality of hierarchies is laminated to finally form one design information 106 as a rendering vector related to the process of the inspecting target.

The rendering data or information of the part label which is assigned to the rendering data or each of the hierarchies described above is stored in the CAD server 201 as a part of the design information and also stored in the secondary storing device 203 or 204 in advance as described above or downloaded from the CAD server 201 whenever the comparison coordinate list information creating step 71 illustrated in FIG. 3(a) is performed.

Further, in step 71 of FIG. 3(a), the comparison coordinate list calculating processor 52 reads out the above described rendering vector and information of the part label from the design information, renders the pattern on the calculator, and calculates the position information where the same patterns are present based on a rendering result. The same pattern information includes a position coordinate including a pattern and area information 112a and 112b including a size for every part label 111a and 111b. The rendering area having the same part label has the same pattern so that a corresponding area where the rendering vector 102 is rendered is calculated for every part label 111a and 111b to calculate the area information 112a and 112b. The calculated positional information of the same pattern is combined for every part label to be stored in the secondary storing device 203.

FIG. 4(c) schematically illustrates an aspect in which the area information 112a and 112b of an area where the same pattern on the design data is present is stored so as to be associated with the part labels C1 and C2.

The part labels 111a and 111b may include a small area near a lower hierarchy of the layout information and include a large area near a higher hierarchy. In the case of the lower hierarchy, the rendering data may be different even in the same labels so that when the same pattern information is used, the labels are treated as separate labels.

FIG. 4(d) is a schematic view illustrating a relationship of planar arrangement on the wafer of the part label and the area information 112a and 112b illustrated in FIG. 4(c). It is known that areas 113a, 113b, and 113c of the label C1 are vertically arranged in one line and areas 114a, 114b, and 114c of the label C2 are two-dimensionally arranged. Further, generally, when an image is detected, the image is detected to be deviated from the design pattern. Therefore, in the case of performing a processing based on the design information, alignment is required. The alignment is required in an area where the same label is not included in a maximum expected deviated amount or in an area of the part label which does not have the same shape.

When the area where the rendering data is expanded is divided into meshes, if the area divided into the meshes is suitable for the alignment, the corresponding mesh is considered as an alignment pattern to form the alignment coordinate list 5 which fits a mesh coordinate and the alignment rendering vector 102. Further, the corresponding mesh forms the same coordinate list 6 in which at least two mesh positions having the same label as the area divided into the meshes are registered In addition, the same coordinate list 6 and the alignment coordinate list 5 are combined to form a comparison coordinate list 4.

Further, it is also considered that a pair of comparison calculations is not present in an initially assumed range of extracting the same pattern. In this case, a size of entire or partial meshes is reduced to perform mesh division again. If the size of the mesh is sufficiently small, the pattern which may be present in the mesh is simplified so that the same pattern may be present even in the complex pattern. Even though the size of the mesh is sufficiently reduced, if there is no same pattern, the area is registered in the comparison coordinate list 4 as a no inspection available area. Alternatively, a pseudo image is generated from an image whose normal pattern is obtained in advance or the design information to perform the inspection. When the pseudo image is used, it is required to consider a generating error so that the defect detecting condition (a threshold value of the defect detection) is set to be a low sensitivity.

FIG. 3(b) is a flowchart illustrating a recipe setting procedure in the inspecting method of the embodiment. In FIG. 3(b), first, the overall controller 48 reads out a standard recipe which is created in advance and stored. Simultaneously, the wafer 36 to be inspected is loaded in the inspecting device and the comparison coordinate list 4 is read out (step 73). The overall controller 48 starts to read out the standard recipe and load the wafer 36 when an operator input a command using the console 49. The loaded wafer 36 is mounted on the sample stage 39. Next, the overall controller 48 sets optical system conditions such as a voltage which is applied to the electron source 31, an excited intensity of the objective lens 34, a voltage which is applied to the charging control electrode 35, and a current which is applied to the deflector 33 based on the read standard recipe, sets an alignment condition which calculates the correction between a coordinate based on the alignment mark of the wafer 36 and a coordinate of the XY stage 37 of the inspecting device based on an image of the standard sample strip 51, sets inspecting area information indicating an area to be inspected of the wafer 36, and sets a calibration condition which registers a coordination of obtaining an image and an initial gain of the detector 43 in order to adjust an amount of light of the image. Next, an inspection sensitivity is set (step 74) and the comparison coordinate is set (step 75).

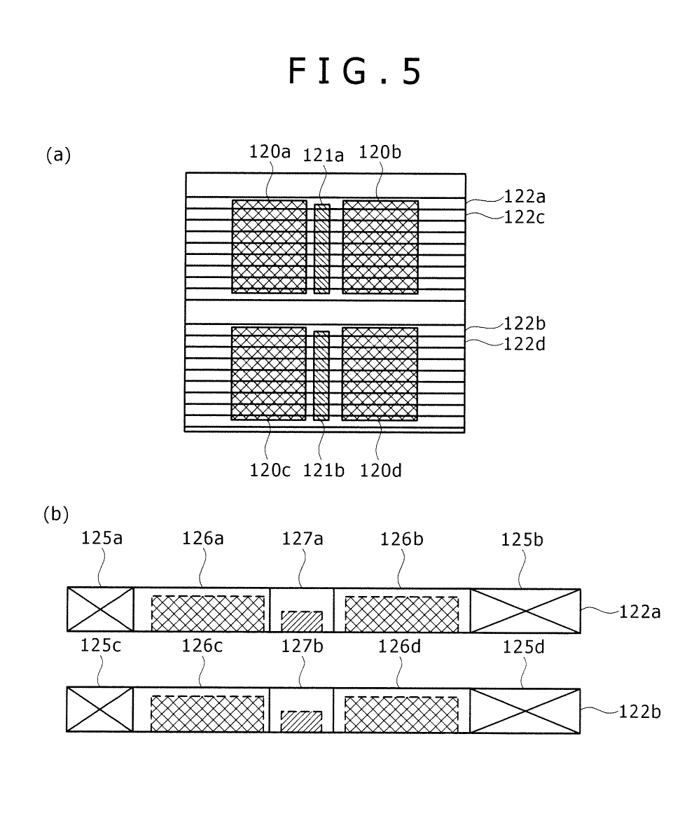

Here, in the read same coordinate list 6, there is a plurality of comparison candidates for one coordinate at the same hierarchy. Further, a comparison candidate pattern with respect to an arbitrary inspecting coordinate at an arbitrary hierarchy may be present in other hierarchy (higher or lower hierarchy). Hereinafter, it will be described that comparison with which comparison candidate is performed with reference to FIG. 5.

FIG. 5(a) illustrates an entire layout in the die and FIG. 5(b) illustrates an expanded layout of swaths 122a and 122b illustrated in FIG. 5(a). Here, the “swath” means an image which is obtained by an inspecting device in which a stage is continuously moved and is obtained by deflecting an electron beam in a direction intersecting with the movement direction of the stage while continuously moving the stage to detect a secondary charged particle signal. Therefore, the overall controller 48 assigns an X direction or a Y direction to the XY stage 37 as input information of the movement direction of the stage. For example, if the movement direction is the X direction, swaths 122a to 122d are obtained by scanning the stage once. Therefore, a comparison candidate is selected by giving a priority to a comparison candidate having the same coordinate in the Y direction which is perpendicular to the stage movement direction. Since the areas 120a and 120b are areas having the same part label 105, these areas are selected as the comparison target.

An area 121a does not have an area having the same label in the same swath and is compared with an area 121b. Therefore, on the swath layout, a non-inspecting area 125a which does not have a pattern and does not require inspection, a comparison area 126a in the same swath where the comparison target is in the same swath, a separate swath comparison area 127a which is compared with a separate swath, and subsequently the same area are disposed in this order from the left side.

Next, a swath is divided into meshes same as the design information and the comparison coordinate list 6 and the alignment coordinate list 5 if necessary are combined to form the comparison coordinate list 4 for every divided mesh and stored in the secondary storing device of a defect determination controller 600 which controls the defect determining unit 47 as data maintained in the recipe. Further, even though the comparison performed between the swaths will be described below, the detected image is once separately saved and when an image to be compared is detected, the image is compared with the image which is separately saved so that the scanning order of the swath is desirably scheduled so as to minimize the amount of separately saved image.

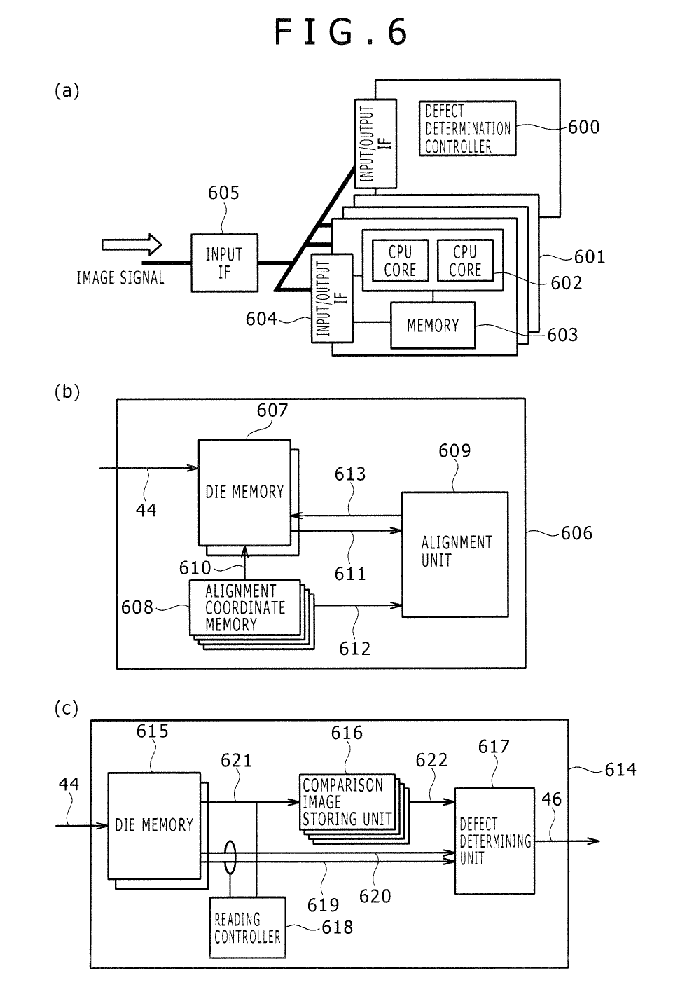

Next, trial inspection (step 76) will be described with reference to FIG. 6. FIG. 6(a) is a configuration view of hardware of the defect determining unit 47 illustrated in FIG. 2, FIG. 6(b) is a block diagram illustrating details of the alignment processing performed in the defect determining unit 47, and FIG. 6(c) is block diagram illustrating details of the defect determination processing performed in the defect determining unit 47.

The defect determining unit 47 has a hardware configuration in which an information processing substrate in which a 1U image processing substrate 601 including a processor unit 602 including a plurality of CPU cores, an image memory 603, and an input/output interface 604 and a defect determination controller 600 which controls the entire unit are mounted is inserted in a backplane. An image signal input to the defect determining unit 47 is distributed into a plurality of image processing substrates through an input interface 605 which is provided at the backplane side. The backplane may have a configuration of a high speed bus such as SRIO or a high speed network represented by InfiniBand or 10GLAN. On a memory space of the memory 603 mounted on the image processing substrate 601, a program stored in the secondary storing device 203 is expanded and the processor unit 602 executes the program to implement an alignment functional block 606 illustrated in FIG. 6(b) or a defect determining functional block 614 illustrated in FIG. 6(c). Further, even though FIG. 6(a) illustrates a mounting type in which an exclusive processing chip is installed as the defect determination controller 600, the function of the defect determination controller 600 maybe implemented by software. In this case, a program which implements the function of the defect determination controller 600 is stored in a memory of any one of the plurality of information processing substrates which is inserted in the backplane.

Next, an alignment processing will be described with reference to FIG. 6(b).

First, before performing step 76 in FIG. 3(b), the same coordinate list 6 stored in the defect determination controller 600 which controls the overall units and the alignment coordinate list 5 including edge image information in the unit of a pixel which is expanded from the rendering vector corresponding to the alignment coordinate are read out.

Next, the XY stage 37 is driven by a command from the overall controller 48 and the deflector 33 is scanned in synchronization with the driving of the XY stage 37 to scan the primary charged particle beam 32 onto the wafer 36 in a raster scanning manner, detect the generated secondary electron using the detector 43, and converts the secondary electron into a digital signal 44 using the AD converter 45 to send the digital signal to the defect determining unit 47. The defect determining unit 47 receives the image signal via the input IF 605 and stores the image signal as the digital signal 44 in a die memory 607. In the actual hardware, the die memory 607 includes a memory 602 on a plurality of the image processing substrates 601. The image obtained by scanning the stage one time is divided by the number of the image processing substrates 601 and the divided images are stored in the memory 602 of each of the image processing substrates 601 in order. The alignment coordinate list 5 of the comparison coordinate list 4 stored in the defect determination controller 600 is distributed into the corresponding image processing substrate 601 in advance or simultaneously to the storage of the image and stored in the memory 603.

By the above control, at the time of performing step 76, signals (126a to 126d and 127a and 127b of FIG. 5) of an area to be inspected among the digital signals 44 output from the AD converter 45 are stored in a plurality of die memories 607.

An alignment processing performed at the time of trial inspection is performed by the following procedure.

(1) A partial image 611 of a mesh cut from the die memory 607 and an edge image 612 of the alignment coordinate list 5 are transmitted to the alignment unit 609 referring to the coordinate data of the alignment coordinate list 5 by a command from the defect determination controller 600. Since the alignment unit 609 includes a processor unit 602 in the actual hardware, a controller (not illustrated) of the image processing substrate 601 reads out the partial image 611 from the memory 603 referring to the coordinate data of the alignment coordinate list 5 and transmits the read partial image 611 to a CPU core of the processor unit 602 together with the alignment coordinate list 5. The CPU core aligns the edge information extracted from the partial image 611 and the edge image 612 of the alignment coordinate list 5 to transmit an alignment result 613 which is a pair of the alignment result and the coordinate data of the alignment coordinate list 5 to the defect determination controller 600.

(2) The defect determination controller 600 determines a distribution of deviated amount of entire swaths based on the transmitted alignment result 613 and stores the determined distribution in the die memory 607 as an amount of corrected coordinate. Since the hardware of the die memory 607 is the memory 603, the distribution is stored to be divided in the corresponding image processing substrate 601.

By these operations, the coordinate of the image corresponding to the mesh of the design information is set. Additionally, even though it is described that the distribution of the deviated amount is calculated in the defect determination controller 600, the distribution of the deviated amount may be calculated only in an area distributed into the image processing substrate 601. Further, the alignment may be performed in two steps. In other words, the deviated amount needs to be uniquely aligned within an available deviated range. However, if there is no location corresponding to the pattern, the distribution of the deviated amount is calculated at a uniquely determined point and the deviated amount is measured in a narrow range using a fact that the deviated amount is expected to be close to the almost linearly interpolated deviated amount at a center point to calculate the accurate distribution even in a disadvantageous pattern.

Next, a defect determination processing will be described with reference to FIG. 6(c).

The logical configuration of the defect determining unit 614 includes the die memory 615, a reading controller 618 which controls a reading operation of the die memory 615, a comparison image storing unit 616 which maintains an image 621 of the die memory 615 when there is no image to be compared in the same swath, and the defect determining unit 617 which compares a detected image 619 read out from the die memory 615 with the reference image 620 or a stored reference image 622 of a previous swath temporally stored in the comparison image storing unit 616 with the detected image 619 to determine a part having a difference as a defect candidate 46. The hardware may have the following correspondence. The die memory 615 corresponds to the memory 603, the reading controller 618 corresponds to an image processing substrate controller (not illustrated), the comparison image storing unit corresponds to the memory 603, and the defect determining unit 617 corresponds to the processing unit 602.

If the alignment is completed, in accordance with the instruction from the defect determination controller 600, referring to the same coordinate list 6, it is determined whether every image in the die memory divided into the meshes in the reading controller 618 is a detected image or a reference image which is stored in the comparison image storing unit 616. Further, referring to the same coordinate list 6, the defect determining unit 617 determines which of the stored reference image 622 and the reference image 620 is compared with the detected image 619 and determines a part having a difference as a result of the comparison with any of them as a defect candidate 64 and transmits the determined part to the defect determination controller 600. The defect candidate 46 includes information on a coordinate of the detected image, a coordinate of the reference or stored reference image, and a feature amount of the defect.

With respect to an image which is divided into at least one mesh, two reference images or one reference image and a reference image from the detected image of a separate mesh, or reference images from detected images of two separate meshes are designated in the same coordinate list 6. By doing this, by setting whether to the detected image, the reference image, or the stored reference image aside, at least two times of comparisons may be performed. Since the die memory 615 includes die memories 603 of the plurality of image processing substrates 601, there may be no reference image in the memory of the same image processing substrate, so that a corresponding image may be obtained from the backplane.

The defect determination controller 600 collects two coordinates, for example, the coordinate of the detected image of the defect candidate 46 and the coordinate of the reference or stored reference image as a coordinate of the defect coordinate and if the same coordinate point are present twice or more, it is determined to be a true defect.

Next, an operation of checking the inspection condition (step 77) will be described. An image of a detected defect portion is detected again with a high resolution or it is checked whether to be the original defect using the image which is used for the defect determination and if no problem is found, it is considered that a correct condition is set but if a problem is found, the condition is set again from a condition of the inspecting sensitivity. If a correct condition is obtained, the recipe is stored and the wafer is unloaded to complete the procedure.

Next, a procedure of main inspection illustrated in FIG. 3(c) will be described. A recipe including the comparison coordinate list is read out, the wafer is loaded, the optical condition is set, alignment is performed with respect to the alignment mark and the calibration is performed to optimize the amount of signals. After performing the calibration, the comparison coordinate is set in the same manner as FIG. 3(b) (step 75) and swath images are detected in a specified order. Further, a defect is determined by the same procedure as the trial inspection described in step 77 of FIG. 3(b) (step 78). The defect information of the inspection result is stored as a result and the wafer is unloaded to complete the procedure.

As described above, the defect inspecting device according to the embodiment uses the pattern information of the design information only for the alignment but does not use the pattern information for the defect determination so that a simulation which estimates a detected pattern or a modification of the pattern is not required, which shortens a pre-processing time. Further, a pattern estimation error caused by the calculation processing such as the simulation or the pattern modification is not generated so that the defect may be detected with a high sensitivity. Further, as illustrated in FIG. 5, among the obtained swath images, an area where the inspection is not necessary such as no pattern portion or a dummy pattern is set as a non-inspecting area based on the design information and the comparison calculation is not performed on these portions so that only essential defect may be extracted. Moreover, the grayscale images of the patterns in the same area are compared to each other referring to the design information so that a minute defect which is equal to or smaller than the size of the pixel even in the comparatively large size of the pixel may be determined with a high sensitivity.

As described above, according to the defect inspecting device of the embodiment, it is possible to provide a high speed electron beam pattern inspecting device and inspecting method which have a short preparation time for inspection and are capable of determining a defect by detecting an image of one die. Further, in the above description, even though an inspecting device in which a stage is continuously moved is described as an example, it is obvious that the configuration of the embodiment is applicable to a step and repeat type inspecting device.

Second Embodiment

In the embodiment, an inspecting device in which the stage is moved asynchronously to a deflecting speed of a primary charged particle beam will be described. Since the entire configuration of the device is the same as the first embodiment, if necessary, the drawings of the first embodiment will be referenced.

As described with reference to FIG. 5, in a sample to be inspected, an area where the inspection is not necessary such as no pattern portion or a dummy pattern (for example, areas 125a to 125d) is present. In the non-inspecting area 125 in which the inspection is not necessary, neither the inspection, nor image detection is necessary. However, in the case of the inspecting device in which the stage is continuously moved, a throughput of the inspection is not improved even though the beam is not irradiated onto no-inspection required area.

Theoretically, a time required to obtain a one line image is constant unless the clock and the number of pixels per line are changed. It is considered that the number of lines required to obtain an image of an entire surface of the die while moving the stage is D and a time required therefor is T seconds. If the number of lines which obtain the image is 100%, the operation is continued for T seconds and if the number of lines which obtain the image is 10%, the operation is continued for 0.1 T seconds. However, if the moving speed of the stage is constantly 100%, it takes T seconds to obtain the image even though the number of lines which obtain the image is 10%.

In the case of the inspecting device in which the stage is continuously moved, a capturing area per unit time is determined by a speed of feeding the stage and a deflecting speed of the primary charged particle beam (deflection frequency). Even though the beam is not irradiated on the no-inspection required area by a beam shielding means such as blanking, the image signal is not output from the detector during that time and thus a blank area of the image is formed in the swath. In other words, by simply stopping irradiating the beam on the no-inspection required area, the throughput of the inspection is not improved but a key point of the high speed inspection is how to reduce the waiting time until an inspection required area moves in a beam irradiating position or in the FOV of the charged particle column. Therefore, by increasing the speed of feeding the XY stage, the throughput of the inspection is improved.

In the case of the conventional inspecting device in which the stage is continuously moved, since a speed of feeding the XY stage is set to a speed of moving the XY stage as much as one pixel in a direction intersecting a scanning line while one scanning line which forms a swath image is scanned by the primary charged particle beam (hereinafter, referred to as a synchronized speed), it is difficult to move the stage at a higher speed.

Therefore, the speed of moving the stage is set to be asynchronous to the speed of deflecting the primary charged particle beam, that is, a condition of controlling the XY stage is set such that a distance of the stage moving during the beam deflecting time of one scanning line is one pixel or larger to increase the captured area per unit time (including the no-inspection required area) as compared with the related art.

In the case of asynchronous control, if nothing is performed, the scanning line of the primary charged particle beam is shifted from a position to be originally scanned to the stage proceeding direction. Therefore, the delay of the beam deflection position with respect to the stage movement is corrected by deflecting a beam in the same direction as the stage moving direction. Accordingly, even though the XY stage is asynchronously operated, the image may be detected in a correct capturing position.

An amount of deflected beam for correcting the deviation of the scanning line is set by the overall controller 48 based on the positional information of the inspection required area and the no-inspection required area in the swath layout illustrated in FIG. 5(b) and a set speed of the XY stage 37 to control the deflector 33. Simultaneously, the XY stage 37 moves at a high moving speed (high asynchronous speed) set by a user of the device through a management console 49. After detecting the image, the defect is determined using the same method as the first embodiment.

Further, there is a physical limitation in a beam deflection distance of the charged particle optical column and the speed of feeding the XY stage cannot be larger than a speed of moving by a maximum deflected width of the beam while the beam scans the one scanning line (otherwise, the position of the scanning line exceeds a range in which the position is corrected by the beam deflection).

Even though there is the above-mentioned restriction, according to the asynchronous control method of the embodiment, the speed of moving the stage is increased to skip the no-inspection required area at a high speed so that the inspecting speed is significantly improved as compared with the related art.

If it is described using a specific example, as a simple case, it is assumed that 100 lines are inspection required areas, adjacent 900 lines are no-inspection required areas, next adjacent 100 lines are inspection required areas, and next adjacent 900 lines are no-inspection required areas, which are repeated. The stage speed is set to be 10 times a speed when the inspection required areas are 100%, to move the stage. Since the stage proceeds by 10 lines while the one line image is obtained, the beam scanning position is set back by nine lines. Hereinafter, similarly, when the 100 lines are repeated, the beam scanning position is set back by 900 lines while the stage proceeds by 100 lines. Since a 101st line is prior to the 900 lines, when the 101st line is detected, the beam scanning position returns to the original position and these procedures are repeated to obtain the image of all inspection required areas at 10 times of high speed without causing a failure.

As described above, in the inspecting device of the embodiment, in addition to the operation and effect of the first embodiment, an operation and effect that the throughput of the inspection is significantly improved may be achieved.

Third Embodiment

In the embodiment, an inspecting device which performs the inspection by varying the size of the pixel in accordance with the inspecting area will be described. Since the entire configuration of the device is the same as the first embodiment, if necessary, the drawings of the first embodiment will be referenced.

As described in FIG. 4(a), in a die to be inspected, a plurality of areas having different pattern densities, such as a memory area 401, a logic area 402, a peripheral circuit area 403, or a dummy pattern area or an area which does not have a pattern is present.

Here, if the pattern density is different, a size of a defect to be detected is different. For example, in an area having the high pattern density, since an average distance between the patterns is small, even a minute defect may be a fatal defect. In contrast, in an area having a low pattern density, an average distance between the patterns is large and the minute defect does not affect the property. Even though a defect is present in the area which does not have the pattern or the dummy pattern area, the defect is not fatal but lots of abnormalities which do not affect the property of the circuit may be present. As described above, a size of the defect to be detected and an inspecting sensitivity are varied depending on the pattern density or the pattern property of the area to be inspected.

In order to change the size of the detected defect or the inspecting sensitivity in accordance with the area, the pixel size at the time of capturing an image may be changed in accordance with the area. In order to perform the above-mentioned control, the overall controller 48 of the inspecting device of the embodiment has management information which describes the correspondence of the positional information of the area and the pixel size and the management information is stored in the secondary storing device 204. Further, the management information is input to the overall controller 48 when the user of the device designates the pixel size on the GUI displayed on the management console 49. For example, the die layout illustrated in FIG. 4(a) is displayed on the GUI, for example, the size of the pixel to be inspected is set for the memory area 401, the logic area 402, the peripheral circuit area 403, or the dummy pattern area or the area which does not have a pattern to input the management information.

Now, at the time of detecting an image for trial inspection (step 76) or at the time of detecting a image of the main inspection (step 78), the overall controller 48 grasps the positional information of the irradiating position of the primary charged particle beam from the stage position and the deflection control information of the primary charged particle beam. The management information is referred to using the information of the grasped beam irradiating position and then information of a size of the pixel in a position where the beam is scanned or irradiated is obtained and the deflector 33 or the AD converter 45 is controlled to obtain a deflecting speed or a sampling clock calculated based thereon. After detecting the image, the defect determination processing is performed by the same method as the first embodiment 1.

According to the embodiment, the image is obtained with an optimal size of the pixel by referring to the design information so that an inspecting device which is capable of obtaining an image at a high speed while detecting a necessary defect for every pattern is achieved.

That is, the inspecting device of the embodiment, in addition to the operation and effect of the first embodiment, an operation and effect that the throughput of the inspection is significantly improved may be obtained.

Fourth Embodiment

In the embodiment, an inspecting device which performs the inspection by extracting a contour line of a pattern rather than a grayscale image will be described. Similarly to the second and third embodiments, since the entire configuration of the device is the same as the first embodiment, if necessary, the drawings of the first embodiment will be referenced.

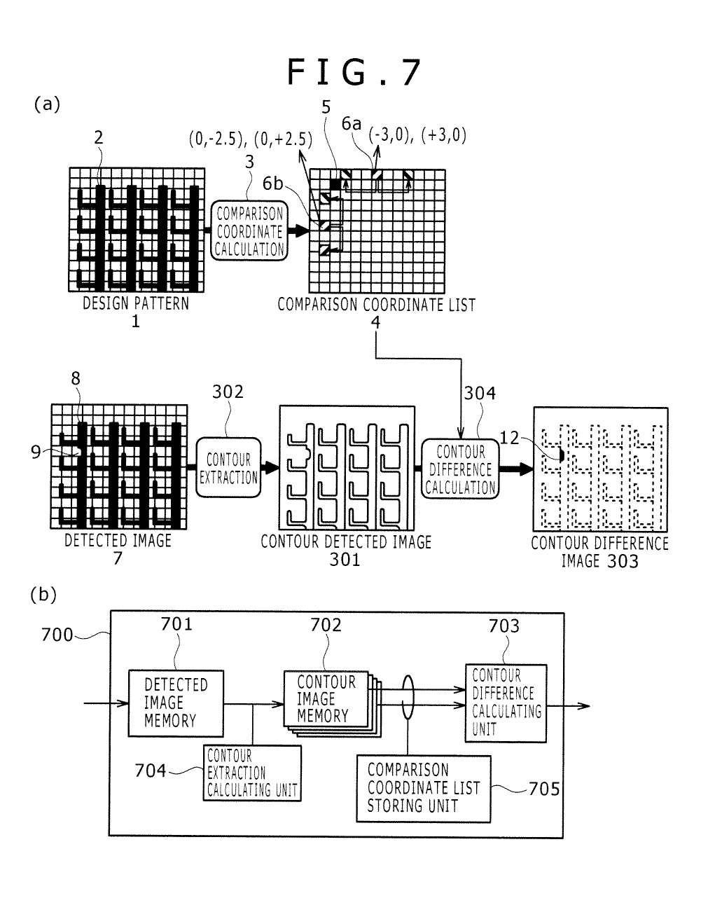

FIG. 7(a) is a conceptual view of inspection according to the embodiment and FIG. 7(b) illustrates a functional block for detecting a defect formed in the defect determining unit 47 of the inspecting device of the embodiment. Further, a hardware configuration of the defect determining unit 47 is the same as the FIG. 6(a).

In FIG. 7(a), a processing of generating a comparison coordinate list 4 by dividing a design pattern 1 into meshes is the same as the processing described in (a) through (b) in FIG. 1 so that the description thereof will be omitted.

A detected image 7 is stored in the detected image memory 701 and cut as a partial image in a contour extraction calculating unit 704. Simultaneously, the contour extraction calculating unit 704 performs contour extraction calculation 302 for the partial image to extract a contour line of the pattern and the contour line is stored in the contour image memory 702. The contour image memory stores contour information corresponding to the plurality of partial images in accordance with the labels of the inspecting areas denoted by C1 and C2 illustrated in FIG. 4(d). In the meantime, the comparison coordinate list which is the same as the first embodiment is stored in a comparison coordinate list storing unit 705 and a contour difference calculating unit 703 reads out contour information of the partial image stored in a contour image memory 702 and performs the contour difference calculation 304 using predetermined contour images by referring to the comparison coordinate list stored in the comparison coordinate list storing unit 705. A location where a significant difference is present in the contour image is determined as a defect position. Further, similarly to the first embodiment, the functional block for detecting a defect illustrated in FIG. 7B is implemented by executing the program stored in the memory 603 by a processor unit 602.

According to the embodiment, when an image is detected using a relatively small pixel, the defect may be more accurately detected.

Further, in accordance with the inspecting area described in the third embodiment and an importance of a defect, the embodiment may be combined with the defect detecting method which changes the size of the pixel or the grayscale comparison may be changed with the contour difference comparison in accordance with the pixel size. By the combined method, for example, the most important location is detected with a high sensitivity, an important location is detected by the grayscale comparison of the minute pixel, and a location where the large defect is a problem is detected with a large pixel size to compare the grayscales. In this method, the pixel size and the algorithm of detecting a defect are changed in accordance with an importance of the defect so that the sensitivity of detecting a defect with a set importance or a defect for every inspecting area is improved. Further, a pixel size suitable for a defect detecting algorithm or a defect detecting algorithm in accordance with the pixel size may be selected so that the type of defect which is capable of being detected is increased as compared with the related art.

Fifth Embodiment

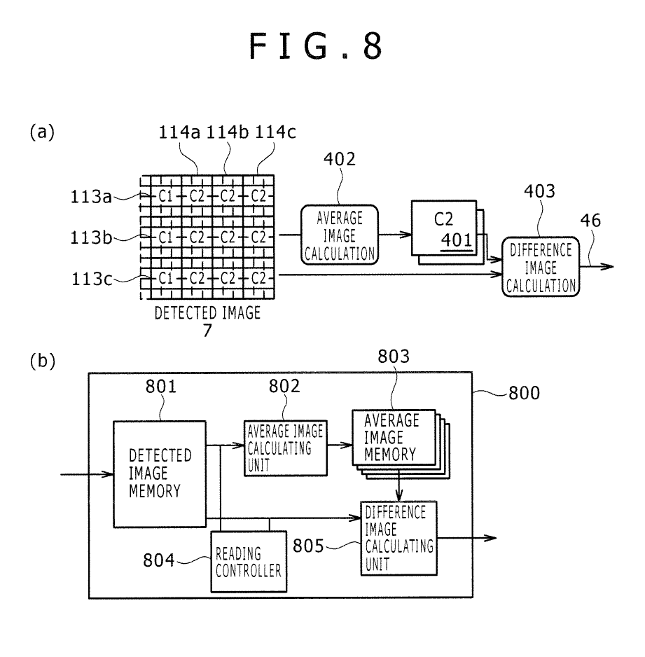

The embodiment is a modification embodiment of the first embodiment and an inspecting method using a golden pattern will be described with reference to FIG. 8. Similarly to the above embodiments, since the entire configuration of the device is the same as the first embodiment, if necessary, the drawings of the first embodiment will be referenced.

FIG. 8(a) is a conceptual view of inspection according to the embodiment and FIG. 8(b) illustrates a functional block for detecting a defect formed in the defect determining unit 47 of the inspecting device of the embodiment. The processing of generating the comparison coordinate list described in the first embodiment or the fourth embodiment is performed using design information and it is considered that a detected image 7 illustrated in FIG. 8(a) is detected at the time of the trial inspection or the main inspection. As described above, there is a plurality of coordinates where the same pattern needs to be formed, so that an average image calculation processing 402 is performed on a plurality of average images 401 and a difference image calculation processing 403 is performed on an image difference between the average image 401 and the detected image 7 to determine a defect 46.

In the functional block 800 for detecting a defect illustrated in FIG. 8(b), the detected image 7 is stored in the detected image memory 701 and a comparison coordinate list is stored in the reading controller 804. The reading controller 804 cuts the detected image 7 into partial images by referring to the comparison coordinate list and outputs the partial image to an average image calculating unit 802 and a difference image calculating unit 805. The average image calculating unit 802 adds a plurality of input partial images to calculate an average and creates an average image which is used as a golden pattern for determining a defect. The created average image is output to the difference image calculating unit 805 and the difference image calculating unit 805 performs the difference image calculation processing 403 on the partial image read out by the reading controller 804 and the average image to detect a defect position.

According to the embodiment, the partial image is compared with the average image so that a portion having a difference may be determined as a defect and thus a real ghost determination is not necessary. Further, extracted contour images may be averaged.

Sixth Embodiment

Another modification embodiment of the first embodiment will be described. Similarly to the above embodiments, since the entire configuration of the device is the same as the first embodiment, if necessary, the drawings of the first embodiment will be referenced.

In the embodiment, instead of the difference image calculation, the defect position is estimated from variation of the patterns in the same pattern forming area. A plurality of statistic amounts 501 is calculated by statistic amount calculation 502 and an edge position such as a variation in an edge position or a grayscale variation along a normal direction of the pattern and a variation of the grayscale value of the image are calculated from the statistic amount 501 in the variation calculating unit 503 and a pattern having a large variation is determined as a defect pattern 504. For example, the error distribution of each image is calculated as a difference from an average grayscale value to determine a maximum value as a maximum error, a frequency distribution of the maximum error is calculated to determine a pattern having an error which is larger than a predetermined threshold value 505 as a defect pattern and determine the maximum value 506 as a variation of the pattern to be the frequency of the maximum variation is used to determine a pattern having the large variation as a defect pattern 504. According to the modification embodiment, the statistic property for every pattern is understood so that a pattern having a large variation may be extracted. Further, even in the same design pattern, an average value is calculated whenever the OPC set to form the pattern is different and a difference of the average values is calculated to evaluate the influence of the OPC.

As described above, according to the modification embodiment, it is possible to provide a high speed circuit pattern inspecting method and inspecting device which have a short preparation time for inspection and are capable of determining a defect by detecting only an image of one die.

Reference Signs List

1 Design pattern

2, 8 Mesh

3 Comparison coordinate calculation

4, 55 Comparison coordinate list

5 Alignment coordinate mesh

6, 53 Same coordinate list

7, 619 Detected image

9 Defect

10, 808 Difference image calculation

11, 12 Difference image

31 Electron gun

32 Primary charged particle beam

33 Deflector

34 Objective lens

35 Charging control electrode

36 Wafer

37 XY stage

38 Z sensor

39 Sample stage

40 Secondary charged particles

41 Reflective plate

42 ExB deflector

43 Detector

44 Digital signal

46 Defect candidate

47 Defect determining unit

48 Overall controller

49 Console

50 Optical microscope

51 Standard sample strip

52 Comparison coordinate list calculating processor

54 Same coordinate list information

71 Same coordinate list information creating step

72 Same coordinate list storing step

73 Same coordinate list reading step

74 Inspection sensitivity setting step

75 Comparison coordinate setting step

76 Trial inspecting step

77 Inspection condition checking step

78 Image detection•defect determining step

101 Rendering data

102 Rendering vector

104 Part at higher hierarchy

105 Part label

106 Design information

111 Process label

112 Area information

113 Area of label C1

114 Area of label C2

120a, b, c, d, 121a, b Pattern having the same label

122a, b, c, d Swath

125a, b, c, d Non inspection area

126a, b, c, d Comparison area in same swath

127a, b Separate swath comparison area

231 Die memory

301 Contour detected image

302 Contour extraction calculation

303 Contour difference image

304 Contour difference calculation

501 Statistic amount

502 Statistic amount calculation

503 Variation calculating unit

504 Defect pattern

505 Threshold value

506 Maximum value

608 Alignment coordinate memory

609 Alignment unit

610 Alignment coordinate

611 Partial image

612 Edge image

613 Deviation amount distribution

616 Comparison image storing unit

617 Defect determining unit

620 Reference image

621 Stored image

622 Stored reference image

806 Average image

807 Average image calculation

1. An inspecting device which inspects a defect on a semiconductor wafer in which a plurality of dies is formed by comparing images of at least two circuit patterns formed on the dies, the device comprising:
a charged particle optical column which irradiates a primary charged particle beam on a sample to be inspected and outputs a detected signal based on an obtained secondary electron or reflected electron; and
a calculating processor which extracts a plurality of positional information of portions having the same shape among the circuit patterns formed on the die using design information of the die and determines a captured area of the image used for the comparison calculation,
wherein the image of an obtained area determined by the calculating processor is captured and the defect is inspected using the image.

2. The inspecting device according to claim 1, wherein positional information of the portions having the same shape is extracted from a circuit pattern formed in one die, and
only an image of the one die is used to inspect the defect.

3. An inspecting device which inspects a defect of a sample to be inspected on which a predetermined pattern is formed, the device comprising:
a charged particle optical column which irradiates a primary charged particle beam on the sample to be inspected and outputs a detected signal based on an obtained secondary electron or reflected electron;
a defect determining unit which determines whether there is a defect using an image signal generated from the detected signal; and
a calculating processor which extracts a plurality of positional information of portions of the pattern having the same shape using design information of the predetermined pattern,
wherein the defect determining unit obtains a plurality of partial images corresponding to the plurality of positional information from the image signal, and
compares two arbitrary images among the plurality of partial images to determine whether there is a defect.

4. The inspecting device according to claim 3, wherein the defect determining unit compares an image of the pattern generated from the design information with respect to a given reference position with an image of the reference position to calculate an amount of correction of a reference position where the partial image is cut from the pattern, and
corrects the reference position by the amount of correction to obtain the partial image.

5. The inspecting device according to claim 3, wherein the defect determining unit extracts a contour line of a pattern of the plurality of partial images, and
compares two arbitrary contour line images among the plurality of generated contour line images to inspect a defect.

6. The inspecting device according to claim 3, wherein the defect determining unit adds the plurality of partial images and calculates an average to generate a reference image, and
forms a difference image between the reference image and one partial image of the plurality of partial images to inspect a defect.

7. The inspecting device according to claim 3, wherein the defect determining unit calculates any one of a variation of an edge position of the pattern, a variation of a contrast, and a variation of a brightness of the plurality of partial images, and
determines a pattern having a large difference from an average value of the variation as a defect.

8. The inspecting device according to claim 3, wherein the defect determining unit compares a first partial image and a second partial image which are included in the plurality of partial images,
further compares the first partial image with a third partial image which is different from the second partial image, and
determines whether a defect is present in the first partial image using the two comparison results.

9. The inspecting device according to claim 3, further comprising:
a control unit which controls a condition of obtaining an image of the charged particle optical column,
wherein the control unit controls the charged particle optical column so as to obtain an image by changing a pixel size for every predetermined area on the sample to be inspected, based on given area information.

10. The inspecting device according to claim 9, wherein the defect determining unit changes inspection by image comparison and inspection by contour line image comparison in accordance with the predetermined area or the pixel size.

11. The inspecting device according to claim 9, wherein the defect determining unit changes an inspection sensitivity in accordance with the predetermined area or the pixel size.

12. The inspecting device according to claim 3, wherein the calculating processor uses information of a no-inspection performed area which is given in advance to extract positional information of a portion having the same shape by avoiding the no- inspection performed area.

13. The inspecting device according to claim 12, wherein the no-inspection performed area is any one of an area which does not have a pattern on the sample to be inspected, a dummy pattern area, and an area which has a defect but does not influence a quality.

14. The inspecting device according to claim 3, wherein the calculating processor divides an image of a pattern generated from the design information into meshes and defines a portion which has the same shape for every mesh.

15. The inspecting device according to claim 3, further comprising:
a sample stage which moves the sample to be inspected in a predetermined direction; and
a charged particle optical column controller which scans the primary charged particle beam on the sample to be inspected in a direction intersecting a movement direction of the sample stage to control the charged particle optical column to output a swath image signal as the image signal,
wherein the defect determining unit determines whether there is a defect by obtaining the plurality of partial images from the swath image signal.

16. The inspecting device according to claim 15, further comprising:
a memory which stores the swath image signal,
wherein if the portion which has the same shape is not present in the same swath, a partial image to be compared is searched from the swath image signal stored in the memory.
